(19) United States
(12) Patent Application Publication
(10) Pub. No.: US 2013/0121754 A1
(43) Pub. Date: May 16, 2013

(54) BALL JOINT AND METHOD FOR MANUFACTURING THE SAME

(71) Applicant: NHK SPRING CO., LTD., Yokohama-shi (JP)

(72) Inventors: Shigeru KURODA, Yokohama-shi (JP); Shuji OHMURA, Yokohama-shi, (JP)

(73) Assignee: NHK SPRING CO., LTD., Yokohama-shi (JP)

(21) Appl. No.: 13/734,232

(22) Filed: Jan. 4, 2013

Related U.S. Application Data
(63) Continuation of application No. PCT/JP2011/064059, filed on Jun. 20, 2011.

(30) Foreign Application Priority Data
Jul. 6, 2010 (JP) 2010-154231

(51) Int. Cl. F16C 11/06

(52) U.S. Cl. CPC F16C 11/06; F16C 11/0685
USPC 403/122; 29/505

(57) ABSTRACT

A ball joint includes, a ball stud with a shaft portion and a ball portion, a ball seat accommodated in a housing and including a recessed spherical surface into which the ball portion is inserted, a projecting portion having an inner diameter smaller than an outer diameter of the ball portion, and a slope portion formed at a hole portion through which the shaft portion is inserted, the slope portion being shaped to have an inner diameter increasing from the projecting portion toward an opening, and a caulking portion including an edge formed at an end wall of the opening in the housing and folded toward an end surface of the ball seat, the edge being arranged so as to overlap the end surface of the ball seat and extending toward the projecting portion and opposite the slope portion.

### CROSS REFERENCE TO RELATED APPLICATIONS

This application is a Continuation Application of PCT Application No. PCT/JP2011/004059, filed Jun. 20, 2011 and based upon and claiming the benefit of priority from prior Japanese Patent Application No. 2010-154231, filed Jul. 6, 2010, the entire contents of all of which are incorporated herein by reference.

### BACKGROUND OF THE INVENTION

1. Field of the Invention

The preset invention relates to a ball joint for use in movable portions of various machines and the like and a method for manufacturing the ball joint, and in particular, to a technique for reliably positioning a ball seat vertically and radially with respect to a housing.

2. Description of the Related Art

A ball joint comprises a housing, a ball stud with a ball portion, a hall seat accommodated in the housing, and a dust cover. A recessed spherical surface is formed within the ball seat so that the ball portion is rotatably fitted into the recessed spherical surface. The ball seat includes a projecting portion formed thereon to inhibit the ball portion from being dislodged from the recessed spherical surface. The inner diameter of the projecting portion is smaller than the outer diameter of the ball portion. Thus, when the ball portion is inserted into the recessed spherical surface, an axial load is applied to the ball stud so that the ball portion forcibly spreads the projecting portion, while the ball portion is inserted into the recessed spherical surface.

A ball joint disclosed in Japanese Patent No. 3,168,229 includes means for fixing a ball seat to a housing as follows. A projection is formed on a bottom portion of a ball seat comprising a thermoplastic resin, and a hole is formed in a bottom portion of the housing. The projection is inserted into the hole, and a tip portion of the projection is heated and deformed (heat caulking) to fix the bail seat to the housing.

### BRIEF SUMMARY OF THE INVENTION

The ball joint and the method for manufacturing the ball joint described above pose the following problems. Since the projection provided on a part of the ball seat is projected through the hole in the bottom portion of the housing and fixed by heat caulking, when for example, an object such as a flying stone impacts the bottom portion of the housing or the bottom portion is subjected to a corrosive liquid such as a strong acid, the projection, made of a synthetic resin, may be damaged to loosen the fixation of the ball seat. Furthermore, since the projection projects from the bottom portion of the housing, disadvantageously the housing has a large axial size and fixing a rod member (tie rod or the like) to the bottom portion of the housing is difficult.

On the other hand, the bail seat is formed of the resin material and thus disadvantageously has low rigidity and has difficulty being positioned when fixed in the housing. When the ball seat fails to be accurately positioned in the housing, the center of oscillation of the ball portion is displaced from a predetermined position, thus precluding intended performance from being demonstrated.

Thus, an object of the present invention is to provide a ball joint which reliably prevents the ball seat from being dislodged from the housing and which allows the ball seat to be reliably positioned vertically and radially with respect to the housing, as well as a method for manufacturing the ball joint.

### BRIEF DESCRIPTION OF THE SEVERAL VIEWS OF THE DRAWING

FIG. 1 is a cross-sectional view showing a ball joint according to a first embodiment of the present invention.

FIG. 2 is a diagram showing a part of a process of manufacturing the ball joint.

FIG. 3 is a diagram showing the relationship between a projecting edge and a reduced diameter portion of the ball joint.

FIG. 4 is a cross-sectional view showing a ball joint according to a second embodiment of the present invention.

### DETAILED DESCRIPTION OF THE INVENTION

Embodiments of the present invention will be described below with reference to the attached drawings.

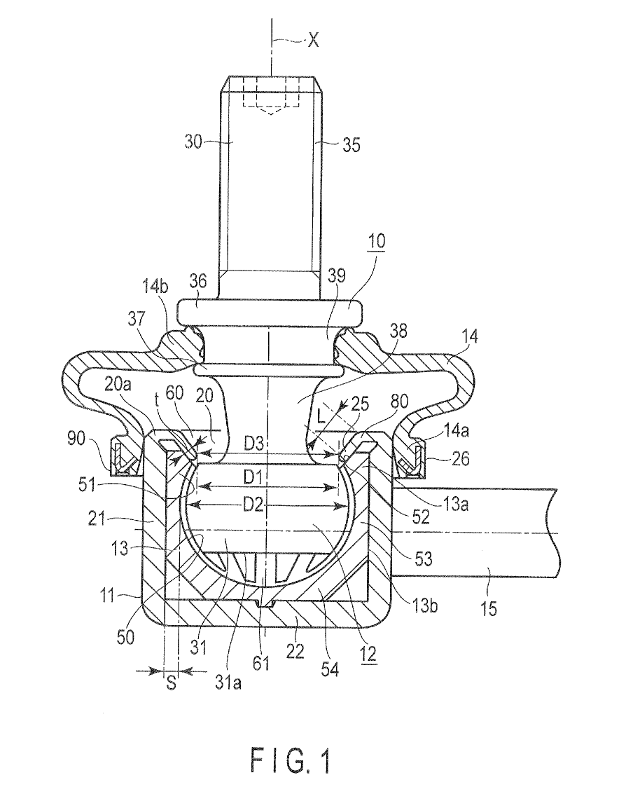

FIG. 1 shows a ball joint 10 according to an embodiment of the present invention. The application of the ball joint 10 is not limited, and the ball joint 10 is used, by way of example, for a stabilizer link that couples a chassis of a car to a stabilizer forming a suspension mechanism portion of the car.

The Pall joint 1 comprises a housing 11, a ball stud 12, a ball seat 13, and a dust cover 14. A rod member 15 is welded to the housing 11.

The housing 11 is formed of metal such as carbon steel and includes en opening 20 positioned above in FIG. 1, a cylindrical peripheral wall portion 21, and a bottom portion 22 positioned opposite the opening 20. A projecting edge 25 is formed on an end wall 20a of the opening 20; the projecting edge 25 has a thickness t and a length L and forms a caulking portion 80 described below. The thickness t of the projecting edge 25 is set equal to 40 to 60% of the thickness of the peripheral wall portion 21. A thickness t smaller than 40% of the thickness of peripheral wall portion 21 results in an insufficient load after deformation, thus precluding the projecting edge 25 from accurately holding an end surface 13a of the ball seat 13. On the other hand, a thickness t greater than 60% of the thickness of peripheral wall portion 21 results in difficult caulking. Furthermore, the length L of the projecting edge 25 is set twice to four times as great as the thickness t. A length L less than twice as great as the thickness t results in an increased caulking force required for caulking and an insufficient margin for holding the projecting edge 25 on the ball seat 13. On the other hand, a length L more than four times as great as the thickness t results in difficult pressing.

A dust cover mounting groove 26 is formed on an outer surface of the peripheral wall portion 21 near the opening 20. The dust cover mounting groove 26 is circumferentially continuous along the peripheral wall portion 21.

The ball stud is formed of metal and includes a shaft portion 30 and a ball portion 31. The shaft portion 30 and the ball portion 31 are integrated together. The shaft portion 30 comprises an external thread portion 35, a first flange portion 36, a second flange portion 37, and a reduced diameter portion 38. The first flange portion 36 has a larger diameter portion than the second flange portion 37. A dust cover mounting portion 39 is formed between the flange portions 36 and 37. The dust cover mounting portion 39 is circumferentially continuous along the ball stud. A tip surface 31a of the ball portion 31 is shaped flat.

The ball seat 13 is formed of a synthetic resin and accommodated within the housing 11. The ball seat 13 includes a spherical surface 50 into which the ball portion 31 is inserted, a projecting portion 51 that serves to prevent the ball portion 31 from being dislodged, a slope portion 52 that guides the ball portion 31 when the ball portion 31 is inserted into the recessed spherical surface 50, a sidewall portion 53 formed around the recessed spherical surface 50, and a bottom wail portion 54. The projecting portion 51, the sidewall portion 53, and the bottom wall portion 54 are integrated together.

The ball portion 31 and the recessed spherical surface 50 are rotatably fitted around an axis X of the ball seat 13. Furthermore, the ball portion 31 is fitted on the recessed spherical surface 50 so that the ball stud 12 can be tilted to the axis X of the ball seat 13 and universally pivoted.

The projecting portion 51 has an inner diameter D1 smaller than the outer diameter D2 of the ball portion 31. The projecting portion 51 inhibits the ball portion 31 placed in the recessed spherical surface 50 from being dislodged from the recessed spherical surface 50.

The slope portion 52 is formed on an inner peripheral surface of a hole portion. 60 of the ball seat 13 through which the shaft portion 30 of the ball stud 12 is inserted. The slope portion 52 is tapered such that the inner diameter of the slope portion 52 increases from the projecting portion 51 toward the opening 20 in the housing 11. The slope portion 52 continues with the end surface 13a of the hall seat 13.

The bottom wail portion of the ball seat 13 is shaped to form a part of a sphere along an outer peripheral surface of the ball portion 31. The bottom wall portion 54 of the ball seat 13 overlaps the bottom portion 22 of the housing space portion 61 is formed between the bottom wall portion 54 of the ball 13 and the tip surface 31a of the ball portion 31 so that a lubricant such as grease can be accommodated in the space portion 61.

A caulking portion 80 is provided at the opening 20 of the housing The caulking portion formed by plastically deforming the projecting edge 25 formed integrally with the end wall 20a of the opening 20 in the housing 11. The caulking portion 80 is desirably provided all along the circumference of the housing 11 but may be provided on a part of the housing circumferentially with respect thereto provided that this structure poses no strength problem.

The caulking portion 80 is arranged within the opening 20 in the housing 11 so as to overlap the end surface 13a of the ball seat 13. The projecting edge 25 extends opposite the slope portion 52 of the ball seat 13 and along the slope portion 52 toward the projecting portion 51. The inner diameter 93 of the projecting edge 25 is set so as to prevent the ball stud 12 from interfering with the trajectory of the ball portion 31 when the ball stud 12 oscillates. Furthermore, as shown in FIG. 3, the projecting edge 25 is shaped to follow the reduced diameter portion 38 when the ball stud 12 is oscillated through the maximum angle. The interference between the reduced diameter portion 38 and the projecting edge 25 prevents a reduction in the angle of oscillation of the ball stud 12.

To form the caulking portion 80, a load P1 acting radially with respect to the ball seat 13 is placed on the projecting edge 25 during a first caulking step. The radial load 21 plastically deforms the projecting edge 23 so that the projecting edge 25 is tilted obliquely inward at about 45°.

Then, during a second caulking step, a load P2 acting along the slope portion 52 of the ball seat 13 is placed on the projecting edge 25. Load P2 plastically deforms the projecting edge 25 so as to sandwich the end surface 13a of the ball seat 13 between the projecting edge 25 and the peripheral wall portion. The root of the caulking portion 80 is bent through the radius of curvature R, thus preventing the caulking portion 80 from excessively compressing the ball seat 13.

Thus, the caulking portion 80 is formed by, first during the first step, applying the radial load 21 to deform the projecting edge so that the projecting edge is tilted at about 45°, and then during the second step, applying the axial load P2. This avoids placing an excessive caulking load on the ball seat 13.

Moreover, as shown in FIG. 1, the caulking portion 80 is formed in an area S between the outer peripheral surface 13a of the ball seat 13 and an extension, in the direction of the axis X, of a position corresponding to the minimum distance between the outer peripheral portion 13b of the ball seat 13 and the recessed spherical surface 50. In the area 3, the appropriate thickness of the ball seat 13 is ensured in the direction of the axis X. Thus, even when a caulking load acting in the direction of the axis X is placed on the ball seat 13, the ball seat 13 can sufficiently withstand the caulking load.

As shown in FIG. 1, one end 14a of the dust cover 14, formed of rubber, is pressed in the dust cover mounting groove 26 of the housing 11 and fixed to the housing 11. The other end of the dust cover 14 is fitted in the dust cover mounting portion 39 of the ball stud 12.

As shown in FIG. 3, when the ball stud 12 is tilted to the axis X of the ball seat 13 by a predetermined amount, the shaft portion 30 of the ball stud 12 comes into abutting contact with the projecting edge 25 to inhibit the ball stud 12 from being further tilted.

The ball joint 10 is manufactured via, for example, steps described below.
(1) The ball portion 31 of the ball stud 12 is inserted into the recessed spherical surface 50 of the ball seat 13.
(2) The ball seat 13 with the ball portion 31 placed therein is inserted into the housing 11.
(3) The radial load P1, acting toward the shaft portion 30, is placed on the projecting edge 25 of the housing 11 to plastically deform the projecting edge 25 so that the projecting edge 25 is tilted obliquely inward. This is a first caulking step.
(4) Load P2, acting along the slope portion 52 of the ball seat 13, is placed on the projecting edge 25 to plastically deform the projecting edge 25 so that the end surface 13a of the ball seat 13 is sandwiched between the projecting edge 25 and the circumferential wall portion. This is a second caulking step.

In the ball joint 10 according to the present embodiment, when a pull-out load acting in the direction of the axis X is placed on the ball stud 12, the projecting portion 51 serves to prevent the ball portion 31 from being dislodged. When a load so excessive as to deform the projecting portion 51 acts in the direction of the axis X, the projecting edge 25 prevents the projecting portion 51 from being deformed.

Furthermore, during the second caulking step, the pressurization is carried out along the slope portion 52. This prevents the ball seat 13 from being subjected an excessive force and thus prevents the ball seat 13 from being excessively compressed.

Moreover, since the projecting edge 25 pressurizes the slope portion 52 of the ball seat 13 all along the circumference thereof, a centripetal effect is exerted to align the axis of the ball seat 13 with the axis X, while pressing the ball seat 13 toward the bottom portion 22 of the housing 11. Thus, the ball seat 13 can be reliably positioned vertically and radially with respect to the housing 11.

Additionally, the ball seat 13 is fixed to the metal housing 11 by caulking the projecting edge 25 formed on the housing 11. The present embodiment can thus increase pull-out strength compared to a conventional technique for fixing the ball seat to the housing by heat caulking.

In addition, no part of the ball seat 13, formed of a synthetic resin, projects out from the bottom portion 22 of the housing 11. Thus, the housing 11 is unlikely to be affected by a flying stone or a corrosive liquid. Moreover, a rod member 16 may be soldered to the bottom portion 22 of the housing 11 at any angle.

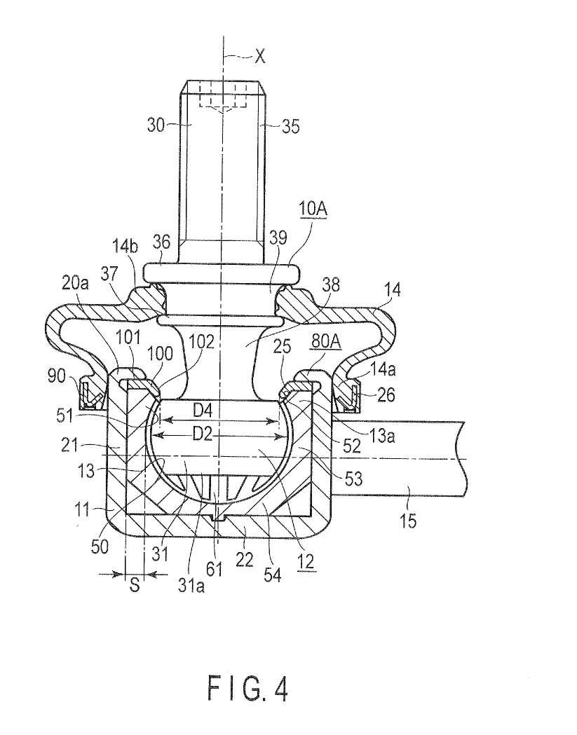

FIG. 4 shows a ball joint 10A according to a second embodiment of the present invention. Components in FIG. 4 which are the same as the corresponding components in FIG. 1 are denoted by the same reference numbers and will not be described in detail.

The ball joint 10A includes a stopper ring 100 provided between the ball seat 13 and the projecting edge 25.

The stopper ring 100 is arranged within the opening 20 in the housing 11 so as to overlap the end surface 13a of the ball seat 13. The stopper ring 100 comprises a ring-like base portion 101 and a stopper portion 102 formed integrally with the base portion 101 on an inner circumference side of the base portion 101.

The stopper portion 102 extends opposite the slope portion 52 of the hall seat 13 and along the slope portion 52 toward the projecting portion 51. The inner diameter D4 of the stopper ring 100 is set so as to prevent the bail stud 12 from interlacing with the trajectory of the hall portion 31 when the ball stud 12 oscillates.

An example of a material for the stopper ring 100 is metal. However, instead of metal, a resin with a strength higher than that of the material of the ball seat 13 may be used or a fiber-reinforced synthetic resin may be used.

A caulking portion 80A is provided at the opening 20 of the housing 11. The caulking portion 80A is formed by plastically deforming the projecting edge 25 formed integrally with the end wail 20a of the opening 20 in the housing 11 to fix the stopper ring 100. The caulking portion 80A is desirably provided all along the circumference of the housing 11 but may be provided on a part of the housing 11 circumferentially with respect thereto provided that this structure poses no strength problem.

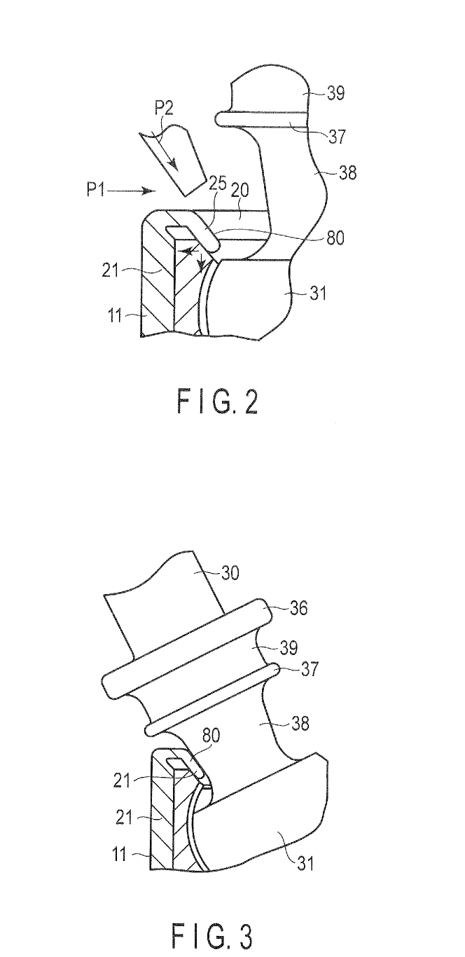

To form the caulking portion 80A, load P1 acting radially with respect to the hall seat 13 is placed on the projecting edge 25 during a caulking step (see FIG. 2). The radial load P1 plastically deforms the projecting edge 25 so that the projecting edge 25 is tilted inward at about 90°. Thus, the the projecting edge 25 is plastically deformed so that the base portion 101 of the stopper ring 100 is sandwiched between the projecting edge 25 and the end surface 13a of the ball seat 13. The root of the caulking portion 80A is bent through the radius of curvature R, thus preventing the caulking portion 80A from excessively compressing the ball seat 13.

The ball joint 10A according to the present embodiment exerts effects similar to those of the ball joint 10 described above.

The present invention is not limited to the above-described embodiments, and many variations may of course be made to the embodiments without departing from the spirit of the present invention.

The present invention provides a ball joint which reliably prevents the ball seat from being dislodged from the housing and which allows the ball seat to be reliably positioned vertically and radially with respect to the housing, as well as a method for manufacturing the bail joint.

What is claimed is:

1. A ball joint comprising:
a metal housing with an opening;
a ball stud with a shaft portion and a ball portion;
a ball seat formed of a synthetic resin and accommodated in the housing, the ball seat comprising a recessed spherical surface into which the ball portion is inserted, a projecting portion having an inner diameter smaller than an outer diameter of the ball portion so as to inhibit the ball portion from being dislodged from the recessed spherical surface, and a slope portion formed at a hole portion through which the shaft portion is inserted, the slope portion being shaped to have an inner diameter increasing from the projecting portion toward the opening; and
a caulk no portion comprising a projecting edge formed at an end wall of the opening in the housing and folded toward an end surface of the ball seat, the caulking portion being arranged so as to overlap the end surface of the ball seat and extending toward the projecting portion and opposite the slope portion.

2. A method for manufacturing a ball joint, the method comprising:
a step of inserting a ball portion of a ball stud into a recessed spherical surface of a ball seat;
a step of inserting the ball seat with the ball placed therein into the housing;
a first caulking step of placing a radial load acting toward the shaft portion of the ball stud, on a projecting edge formed at an end wall of an opening in the housing to plastically deform the projecting edge in such a manner that the projecting edge is tilted obliquely inward; and
a second caulking step of placing, on the projecting edge, a load acting along a slope portion formed at a hole portion formed in the hail seat and through which the shaft portion is inserted, the slope portion being shaped to have an inner diameter increasing from the projecting portion toward the opening, the placing of the load plastically deforming the projecting edge so as to sandwich the end surface of the ball seat between the projecting edge and the housing.
